(19) United States
(12) Patent Application Publication
(10) Pub. No.: US 2012/0327132 A1
(43) Pub. Date: Dec. 27, 2012

(54) IMAGE DISPLAY APPARATUS AND METHOD

(75) Inventors: Shinichi TATSUTA, Tokyo (JP); Toru KAMBAYASHI, Chigasaki-shi (JP); Shinichi UEHARA, Tokyo (JP); Masako KASHIWAGI, Yokohama-shi (JP); Taisuke OGOSHI, Kawasaki-shi (JP); Takahiro KAMIKAWA, Tokyo (JP)

(73) Assignee: KABUSHIKI KAISHA TOSHIBA, Tokyo (JP)

(21) Appl. No.: 13/430,135

(22) Filed: Mar. 26, 2012

(30) Foreign Application Priority Data
Jun. 24, 2011 (JP) 2011-141095

(51) Int. Cl. G09G 5/10

(52) U.S. Cl. 345/690

(57) ABSTRACT

According to one embodiment, an image display apparatus includes a light-emitting source, a light modulation unit, a first control unit and a display. The light-emitting source emits a light beam. The light modulation unit is configured to modulate the light beam to generate data beams related to image data item displayed in a unit pixel region, and the unit pixel region includes at least one column of pixels defined by dividing all pixel region. The first control unit is configured to control beam paths of the data beams to guide the data beams to the unit pixel region. The display displays a parallax image by emitting the corresponding data beams from unit pixel regions of the all pixel region.

### CROSS-REFERENCE TO RELATED APPLICATIONS

This application is based upon and claims the benefit of priority from prior Japanese Patent Application No. 2011-141095, filed Jun. 24, 2011, the entire contents of which are incorporated herein by reference.

### FIELD

Embodiments described herein relate generally to an image display apparatus and method.

### BACKGROUND

The replacing of conventional cathode-ray tube monitors with flat panel displays (FPD) represented by the liquid crystal panel has fast proceeded. Almost types of displays, not only business-use monitors and personal computer monitors, but also the household television monitors, are now being replaced by FPDs. Further, it is now attempted to enhance image quality to a high-definition level. In this trend, three-dimensional (3D) image display techniques, i.e., novel display function, have undergone vigorous development, now enabling people to enjoy 3D broadcast programs at home.

As the techniques for viewing 3D broadcast programs, various 3D display systems are available. Some systems use dedicated eyeglasses. Some others use special displays, not using dedicated eyeglasses.

As a technique other than these, the holographic display is available, which utilizes holography technology.

### BRIEF DESCRIPTION OF THE DRAWINGS

FIG. 1 is a block diagram illustrating an image display apparatus according to a first embodiment;

FIG. 2 is a diagram illustrating the beam paths of data beams in the image display apparatus;

FIG. 3 is a flowchart illustrating an exemplary operation of the image display apparatus;

FIGS. 4A and 4B are diagrams illustrating an example of a slit shutter;

FIG. 5 is a diagram illustrating an exemplary lens for use in a display;

FIG. 6 is a flowchart illustrating an exemplary modulated data generating process;

FIG. 7 is a block diagram illustrating an image display apparatus according to a modification of the first embodiment;

FIG. 8 is a block diagram illustrating an image display apparatus according to a second embodiment; and

FIG. 9 is a block diagram illustrating an image display apparatus according to a third embodiment.

### DETAILED DESCRIPTION

The 3D image display apparatus using, as means for viewing 3D images, eyeglasses incorporating liquid crystal shutters or polarizing elements, has been put to practical use because it is well compatible with the FPD. Various 3D image apparatuses of this type are available at present. In any 3D image display apparatus of this type, left-eye 2D images and right-eye 2D images are alternately displayed. The left-eye 2D image and the right-eye 2D image are switched at the eyeglasses any viewer wears and are applied to the left and right eyes of the viewer, respectively. The 3D image display apparatus has only low technical complexity, though its FPD frame rate must be twice as high as before. It is, however, disadvantageous in the following respects.

First, the viewer must wear the dedicated eyeglasses to enjoy seeing 3D images. Further, the viewer cannot see 2D images well, while wearing the dedicated eyeglasses to see 3D images. In other words, it is difficult for the viewer to adapt his or her eyes quickly from a 3D image to a 2D image, or vice versa. Still further, 3D images appear doubled to any viewer (user) not wearing the eyeglasses. Thus, the viewer must take off the dedicated eyeglasses in order to view 2D images, and must wear them in order to perceive 3D images. This is a factor that discourages the widespread of 3D programs broadcasting. Furthermore, any viewer who keeps wearing the dedicated eyeglasses and viewing 3D images may have uncomfortable feeling or may be tired.

Moreover, the two images the viewer sees at the left and right eyes, respectively, do not change even if the viewer moves. Consequently, motion parallax, which changes these images as the viewer moves, cannot be obtained at all.

Another type of a 3D display has been developed, which does not involve the use of dedicated eyeglasses and which is based on the technology using lenticular lenses and parallax barriers. The 3D display of this type enables the user to see 3D images without wearing eyeglasses, and also to acquire motion parallax when he or she moves. However, the more parallaxes, the higher resolution the FPD should have. The number of parallaxes available is limited, nevertheless. If the parallaxes available are fewer than necessary, the viewer cannot perceive natural 3D images in more viewing regions. In other words, the viewer can see 3D images in a fewer viewing regions.

In the case of the holographic display, the pixel pitch and number of pixels, which the special light modulator (SLM) must have in order to display a moving picture, are too much to achieve. Besides, the amount of data calculated to make the display work is tremendous. The more pixels the display has (that is, the higher the resolution the display has), the higher will be the manufacturing cost of the display.

In general, according to one embodiment, an image display apparatus includes a light-emitting source, a light modulation unit, a first control unit and a display. The light-emitting source emits a light beam. The light modulation unit is configured to modulate the light beam to generate data beams related to image data item displayed in a unit pixel region, each of the data beams are determined by a position in a pixel and output angle corresponding to the position, and the unit pixel region includes at least one column of pixels generated by dividing all pixel region. The first control unit is configured to control beam paths of the data beams to guide the data beams to the unit pixel region. The display displays a parallax image by emitting the corresponding data beams from unit pixel regions of the all pixel region.

Hereinafter, an image display apparatus and method according to embodiments will be described with reference to the drawings. In the embodiments below, parts denoted at each common reference symbol operate in the same manner as each other, and reiterative descriptions will be appropriately omitted.

### First Embodiment

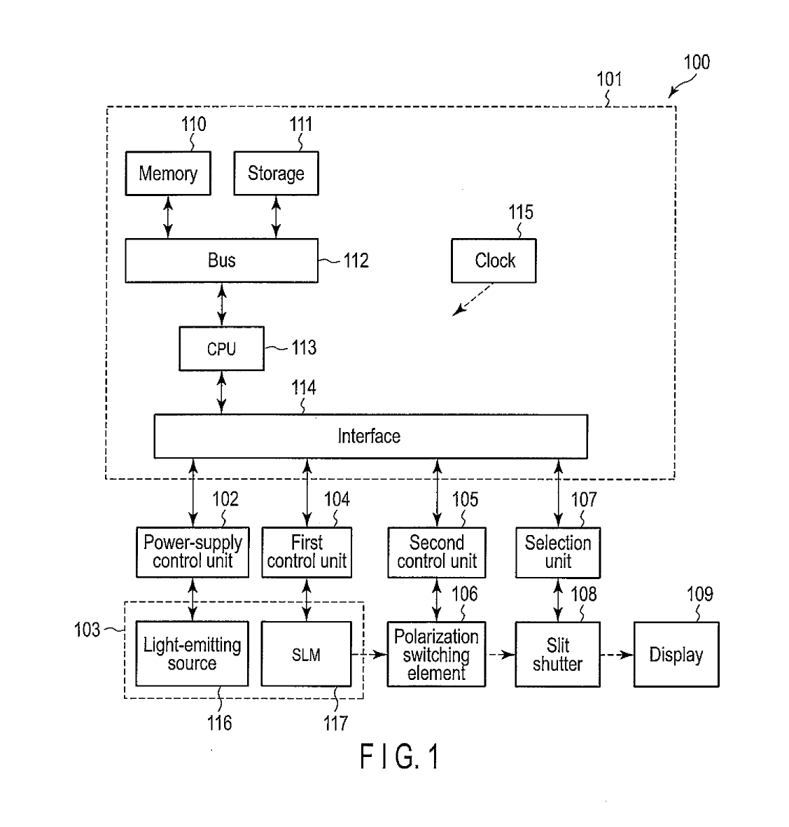

An image display apparatus according to a first embodiment will be described with reference to the block diagram of FIG. 1. The image display apparatus 100 according to the first embodiment includes a light source control unit 101, a power-supply control unit 102, a light source 103, a first control unit 104, a second control unit 105, a polarization switching element 106, a selection unit 107, a slit shutter 108, and a display 109. The light source control unit 101 includes a memory 110, a storage 111, a bus 112, a central processing unit (CPU) 113, an interface 114, and a clock 115. The light source 103 includes light-emitting sources 116 and a spatial light modulator (SLM) 117. The SLM 117 is also called a light modulation unit. The second control unit 105, polarization switching element 106, selection unit 107 and slit shutter 108 are collectively called a first control unit.

In the first embodiment described below, the display 109 has 1920 (in the row direction)×1080 (in the column direction) pixels, thus having a high-definition (HD) resolution. Each pixel is square-shaped, having a size of 1×1 mm. Every pixel has 240 parallaxes in the horizontal direction, and a display frame rate of 60 Hz. These parameters of the display 109 may be changed in accordance with a specification change.

The memory 110 is an ordinary-type one, such as SRAM. The memory 110 temporarily stores image data items including the parallax data items for each pixel.

The storage 111 stores the image data items.

The bus 112 serves to exchange data between the memory 110, storage 111 and CPU 113.

The CPU 113 receives an image data item from the memory 110 or storage 111 through the bus 112. The CPU 113 then performs a process of, for example, generates a 2D data item including the parallax data items of pixel for use in displaying image data items.

The interface 114 transfers data between the CPU 113, on the one hand, and the power-supply control unit 102, first control unit 104, second control unit 105 and selection unit 107, on the other hand.

The power supply control unit 102 receives a control signal from the CPU 113 through the interface 114. In accordance with the control signal, the power-supply control unit 102 controls the light source 103, causing the light source 103 to emit light or stop emitting light.

The power-supply control unit 102 receives a control signal from the CPU 113 through the interface 114, and controls the light-emitting sources 116 in accordance with the control signal.

The light-emitting sources 116 are light-emitting elements such as laser diodes (LDs), and each element emits a light beam. The light-emitting sources 116 are preferably LDs, each having high directivity, being small, consuming little power and having a long lifetime. Alternatively, the light-emitting source 116 may be light-emitting diodes (LEDs), organic electroluminescent elements, solid-state lasers, gas lasers, or second harmonic generation (SHG) elements. Still alternatively, the light-emitting sources 116 may be light-emitting elements for use in the versatile projector, such as halogen lamps or mercury lamps.

If the light-emitting sources 116 are lasers or LEDs, three are used to emit three beams of primary colors, i.e., R (red), G (green) and B (blue), respectively, for one pixel, in order to display a color image. Hereinafter, the embodiment will be described on the assumption that three elements for emitting RGB beams, respectively, constitute one light-emitting source, for simplicity of explanation, except for special cases. The light emitted from any light-emitting source 116 is shaped as it passes through a pinhole or a collimator lens.

The first control unit 104 receives 2D data item from the CPU 113 through the interface 114, and controls the SLM 117, causing the SLM 117 to display a 2D image.

The SLM 117 is a digital micromirror device (DMD) or a liquid crystal panel (LCOS), which are modulation devices having a two-dimensional array. The SLM 117 receives 2D data item from the second control unit 105 and generates a data beam determined by a specific position and a specific output angle corresponding to the specific position. The position and an output angle of the data beam are a parallax data item of the image.

In order to simplify the downstream optical system and to increase the frame rate, it is desirable that the SLM 117 has a two-dimensional array, which accomplishes 2D modulation at a time. Nonetheless, the SLM 117 may be a linear-array device that utilizes optical micro-electro-mechanical system (MEMS), performing scan-type modulation. For simplicity of explanation, the panel is assumed to be one that can achieve gradation expression. If the SLM 117 is a device that can take on or off state, like a DMD, the on/off time ratio may be adjusted to achieve gradation expression.

The pixels of the SLM 117 may be shaped like a square, or a rectangle having such an aspect ratio that it appears almost square. In present embodiment, however, it is desirable that each pixel is shorter in the horizontal direction than in the vertical direction, by a distance that is equivalent to parallax, in the modulation area of the SLM 117. If the SLM 117 is a device having 1920 (in the row direction)×1080 (in the column direction) pixels, its pixels are associated, in the vertical direction, with 1080 pixels of any column of the display 109, respectively, and in the horizontal direction, with 8 pixels of the display 109. It should be noted here that 8 (in the horizontal direction)×1080 (in the vertical direction) pixels of the display 109 define a “unit pixel region.” The unit pixel region is at least one of the pixel columns into which the entire pixel region has been divided. In present embodiment, 1 (in the horizontal direction)×1080 (in the vertical direction) pixels form one column, and every eight columns define one unit pixel region. In the display 109, the 8 (in the horizontal direction)×240 parallaxes are modulated by the 1920 pixels of the SLM 117.

Hence, the light source 103 may include lenses that convert the magnification to 1 (in the horizontal direction): 240 (in the vertical direction). The lenses are a group of, for example, cylindrical lenses. Instead of these lenses, mirrors may be used in combination. The following description is based on the assumption that the light beam emitted from the light source 103 and then modulated has a cross section of 8 mm (in the horizontal direction)×1080 mm (in the vertical direction). If the magnification is converted to achieve enlargement or reduction in a downstream optical system, the light source 103 may have a different aspect ratio or size. The light source 103 may be designed in consideration of the manufacturing cost of the image display apparatus 100.

The second control unit 105 receives a control signal from the CPU 113 through the interface 114, and controls the polarization switching element 106 in accordance with the control signal.

The polarization switching element 106 is, for example, a liquid crystal layer or a half-wave plate. The polarization switching element 106 switches the polarization of (either P polarization or S polarization) of the data beam, when it is controlled by the second control unit 105.

The selection unit 107 receives a control signal from the CPU 113 through the interface 114, and controls the slit shutter 108 in accordance with the control signal.

Controlled by the selection unit 107, the slit shutter 108 allows the data beam to pass through any desired unit pixel region of the display 109 and prevents the data beam from reaching the other unit pixel regions of the display 109.

The display 109 includes, for example, cylindrical lenses and a diffuser (all described later). In the display 109, the data beam coming through the slit shutter 108 emerges from the unit pixel region. The light emitted from the display is diffused by, for example, a lens, forms an image including parallax (i.e., parallax image).

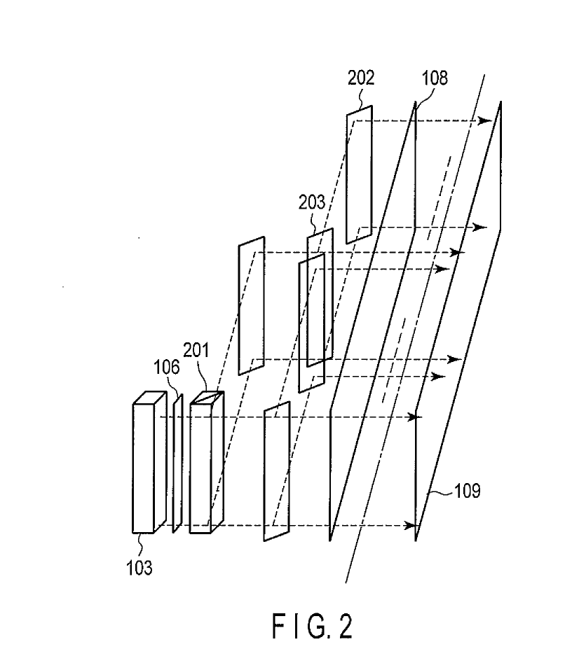

The beam path of the data beam from the light source to the display in the image display apparatus 100 according to present embodiment will be described with reference to FIG. 2.

As shown in FIG. 2, the image display apparatus 100 includes a light source 103, a polarization switching element 106, a polarized beam splitter (PBS) 201, a mirror 202, a half-silvered mirror 203, a slit shutter 108, and a display 109. The light source 103, polarization switching element 106, slit shutter 108 and display 109 are identical to those shown in FIG. 1 and shall not be described.

The PBS 201 splits the light beam emitted from the light source 103 into a P-wave and an S-wave.

The mirror 202 is an ordinary mirror and is used to control the beam path of the data beam to the display 109.

The half-silvered mirror 203 splits the input light beam into two beams. One of these beams travels straight forward, and the other beam is reflected.

In the apparatus of FIG. 2, the half-silvered mirror 203 is arranged between the light source 103 and the PBS 201. Alternatively, the half-silvered mirror 203 may be arranged in the light source 103, for example at the output of the light-emitting source 116, to receive the light beam just shaped, or at the input or output of the SLM 117.

The beam path of the data beam, which extends from the light source 103 to the display 109, will be described below.

The light beam emitted from the light source 103 first passes through the polarization switching element 106 and the PBS 201. The light beam is then switched, alternately to two beam paths. Instead, two light-emitting sources 116 may be used and so arranged to emit two light beams polarized, respectively, in two directions orthogonal to each other. In this case, the beam path switching frequency can be increased, regardless of the response speed of the polarization switching element 106. Moreover, the switching frequency may be mechanically controlled by driving the slit shutter 108 or the mirror 202. The switching frequency may be controlled by any other method, so far as the beam path can be switched at the response speed required. Further, the data beam may be merely split into two beams by a half-silvered mirror, instead of switching the beam path, if no problems arise in outputting the data beam or in the response speed.

The data beams, thus obtained at the polarization switching element 106, are alternately, in time, guided to the left half and right half of the display 109. In present embodiment, the data beam is guided to the right half of the display 109 by using one mirror and 119 (one-hundred nineteen) half-silvered mirrors, to the left half of the display 109 by using two mirrors and 118 (one-hundred eighteen) half-silvered mirrors. Thus, the data beam is allocated to 240 unit pixel regions, each having 1920 pixels (=8 pixels×240 parallaxes)×1080 pixels (in the vertical direction). Without using the half-silvered mirror 203 and the mirror 202, the data beam may be allocated to the unit pixel regions by using optical waveguides such as optical fibers. In whichever case, two identical data beams are irradiated two associated unit pixel regions of the left and right halves of the display 109, at the same time at 1/120 optical power.

The optical power may differ from pixel region to pixel region because of the arrangement of the half-silvered mirror 203 or mirror 202. In this case, a neutral density (ND) filter, for example, may be used to adjust the optical power, or the light source control unit 101 may perform a control to suppress the difference in optical power.

The slit shutter 108 receives the data beam guided by the mirror 202 or the half-silvered mirror 203 and shields part of the data beam. Thus, the slit shutter 108 guides the remaining part of the data beam to only the selected pixel regions of the display 109, not to all pixel regions thereof. The slit shutter 108 may be a liquid crystal shutter, a mechanical shutter, a mirror-driven shutter, or any other type, so long as it can guide the data beam to any selected pixel regions.

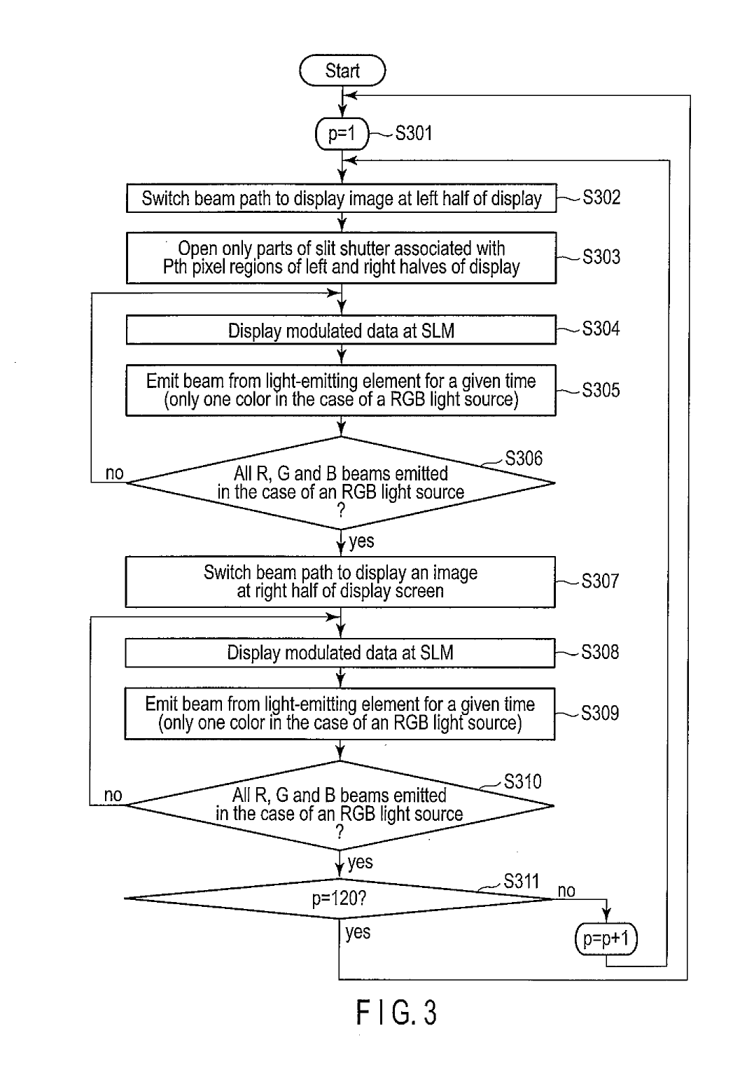

An example of the operation of the image display apparatus 100 according to the first embodiment will be explained with reference to the flowchart of FIG. 3.

In Step S301, counter P is set to a count of 1.

In Step S302, the polarization switching element 106 switches the beam path to display an image at the left half of the display 109.

In Step S303, the slit shutter 108 opens at two parts associated, respectively with the Pth pixel regions of the left and right halves of the display 109. As a result, the data beam can pass through these parts of the slit shutter 108.

In Step S304, the first control unit 104 receives the 2D data item including parallax data items coming from the light source control unit 101. The first control unit 104 causes the SLM 117 to display the 2D data item.

In Step S305, the power-supply control unit 102 makes the light source 103 emit a beam for a given time. The data beam is guided in the above-mentioned beam path. As a result, a data beam that has passed through the SLM 117 is guided to the display 109.

In Step S306, the power-supply control unit 102 determines whether or not the light-emitting sources 116 have emitted RGB beams, respectively, if they constitute an RGB light source. If the light-emitting sources 116 have emitted RGB beams, the process proceeds to Step S307. If the light-emitting sources 116 have not emitted RGB beams, the process returns to Step 305, in which the light-emitting sources 116 are repeatedly switched from one to another, until all three color beams, i.e., RGB, are emitted from the light source 103.

In Step S307, the polarization switching element 106 switches the beam path to display an image at the right half of the display 109.

In Step S308, the first control unit 104 causes the SLM 117 to display the 2D data item, as in Step 304.

In Step S309, the power-supply control unit 102 makes the light source 103 emit a beam for a given time. The data beam is guided in the above-mentioned beam path. As a result, as in Step 305, the display 109 displays an image defined by the data beam that has passed through the SLM 117.

In Step S310, the power-supply control unit 102 determines whether or not the light-emitting sources 116 have emitted all three color beams, i.e., RGB beams. If the light-emitting sources 116 have emitted RGB beams, the process proceeds to Step S311. If the light-emitting sources 116 have not emitted RGB, the process returns to Step S309, in which the light-emitting sources 116 emits the light beam of the next color.

In Step S311, the counter P determines whether or not the process has been completed for half the pixel regions of the display 109. More precisely, the counter P determines whether or not the count of the counter P has reached 120. If the process has been completed for half the number of pixel regions, the apparatus 100 will return to Step S301, in which the counter P is set to a count of 1. Then, Step 302 et seq. are performed. If the process has not been completed for half the pixel regions in Step 311, the count of the counter P is increased by one. Then, the process returns to Step S302, and Steps 302 et seq. are performed again.

The steps described above are repeated at the display frame rate of 60 Hz. The viewer can therefore perceive the image as 3D image having 240 parallaxes.

In the steps described above, the slit shutter 108 allows the data beam to pass through the two pixel regions associated with the left and right halves of the image, respectively. If the beam path is switched more times, the slit shutter 108 needs to have, but a lower response speed.

More specifically, if the beam path is switched one more time, or two times (by using three switching elements), among four beam paths, the response speed the slit shutter 108 must have will be reduced to half the value. In this case, the slit shutter 108 allows the data beam to pass through four pixel regions at all times. Further, the number of pixel regions one SLM 117 works for may be decreased, and the number of light sources 103 is increased in proportion, the response speed of the slit shutter 108 can be more decreased. Assume two light sources 103 are used, each for 120 pixel regions, i.e., half the number specified above. Then, the SLM 117, polarization switching element 106 and slit shutter 108 need to have only half the response speed. In an extreme case, 240 (two-hundred forty) light sources 103 may be arranged, in one-to-one relation with the pixel regions. If this is the case, the polarization switching element and the slit shutter 108 can be dispensed with, and the SLM 117 needs to display images at a frame rate of only 60 fps, which is the frame rate of the display 109. Thus, the image display apparatus 100 may be designed in consideration of its manufacturing cost.

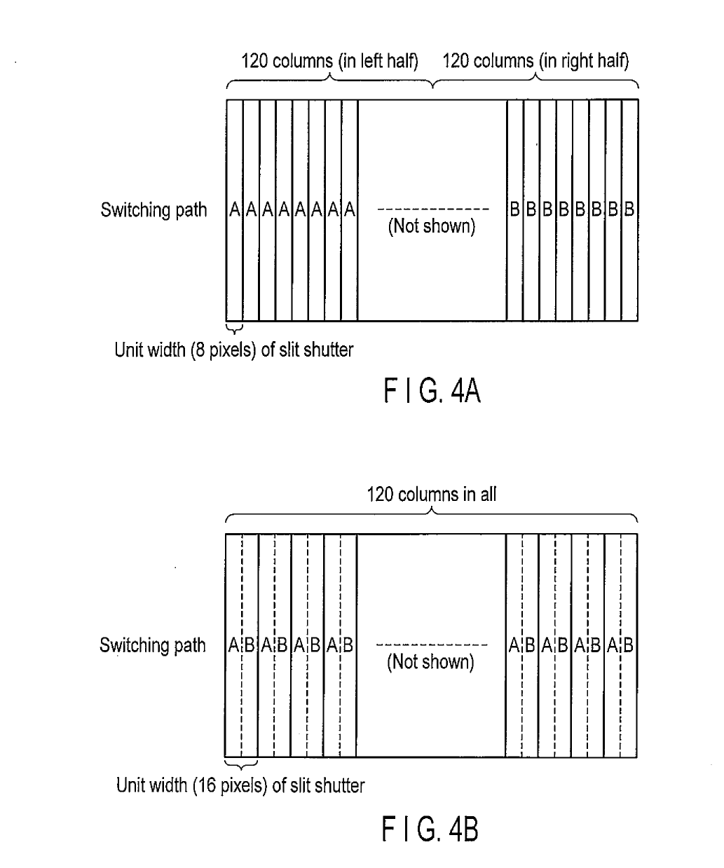

An example of the slit shutter 108 will be described with reference to FIGS. 4A and 4B.

FIG. 4A shows a case where two beams obtained by splitting the data beam are guided to the left and right halves of the display 109, respectively. FIG. 4B shows a case where the two beams are alternately guided to the unit pixel regions of the display 109.

A and B in FIGS. 4A and 4B indicate any two regions associated with two beam paths, respectively, which the PBS 201 switches one to the other as shown in FIG. 2. While one beam path is being selected, the region A is irradiated with a beam coming from the light source. While the other beam path is being selected, the region B is irradiated with a beam coming from the light source.

As shown in FIG. 4A, two beams, switched one to the other, are alternately guided, in time, to the left and right halves of the display 109, respectively. Instead, as shown in FIG. 4B, the data beams may be alternatively guided to any two adjacent pixel regions, from one side of the display 109. In this case, however, the mirror 202 and half-silvered mirror 203, both shown in FIG. 2, must be so arranged that the beam paths A and B may be alternately juxtaposed in the display 109. If the data beams are irradiated as shown in FIG. 4B, the unit pixel region of the slit shutter can be twice as broad, the display 109 can be divided into half as many parts. That is, in the case shown in FIG. 4A, each unit pixel region of the slit shutter 108 includes 8 pixels, dividing the display 109 into 240 columns. In the case shown in FIG. 4B, each unit pixel region of the slit shutter 108 includes 16 pixels, dividing the display 109 into 120 columns.

If two polarizing filters orthogonal to each other are arranged at regions A and B, respectively, they will function as the PBS 201. In this case, the PBS 201 can be replaced by a half-silvered mirror.

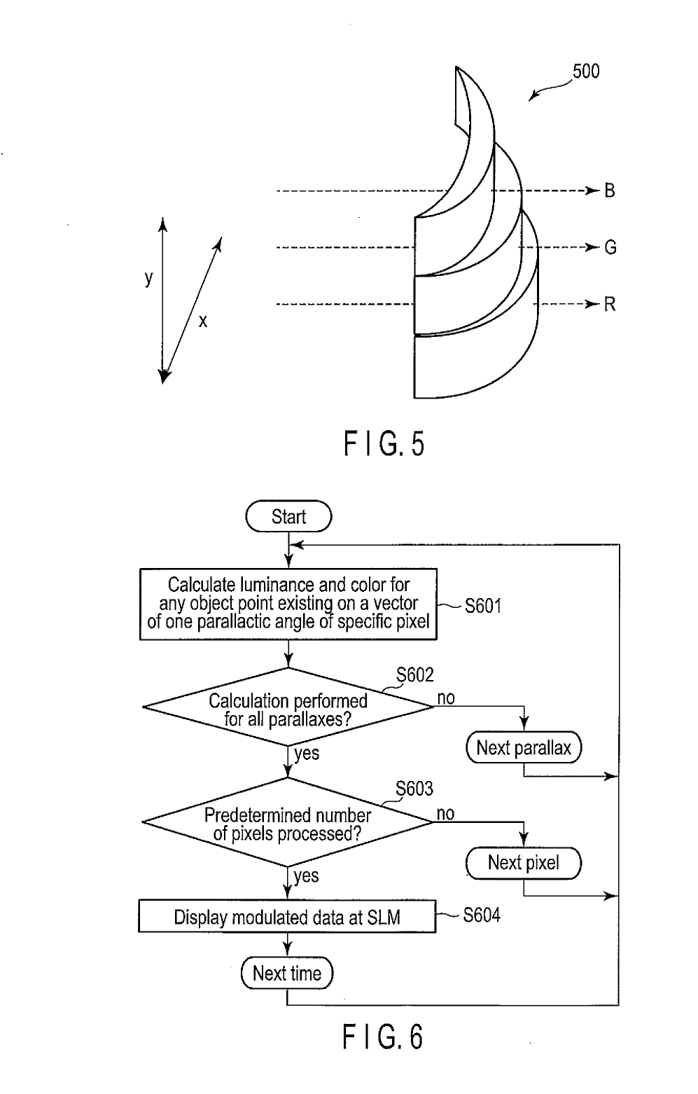

A lens that may be incorporated in the display 109 will be described with reference to FIG. 5.

FIG. 5 shows a cylindrical lens 500 corresponding to one pixel. The data beam coming through the slit shutter 108 first travels through the cylindrical lens 500 (not shown in FIG. 2) included in the display 109 and then travels through, and emerges from, a diffuser (not shown in FIG. 2). The data beam therefore reaches the viewer's eyes.

The cylindrical lens 500 is designed to allocate the input beam to 240 parallaxes and to provide, at the same time, a sufficiently large view angle. The lens 500 may be a combination of lenses or may be formed of concentric lenses, each for one pixel. The data beams for the respective pixels of the SLM 117 are guided to the cylindrical lens 500, each displaced from the next one by 1 mm. It is sufficient for these data beams to emerge at different angles for 240 parallaxes, over an inadequate range of angle. That is, the output side of the optical waveguide (e.g., column of optical fibers) divided into 240 segments per pixel may be broadened to guide the input data beam directly in the angle of emergence.

Note that the cylindrical lens 500 shown in FIG. 5 is a cylindrical lens designed for use in combination with the light-emitting sources 116 that emit RGB beams. If any chromatic aberration becomes problematical, the cylindrical lens is divided into three stages in the vertical direction, and the three stages are designed as lenses optimal to the RGB beams, respectively. In order to displace the RGB beams in the vertical direction, it is good enough to displace the light-emitting sources 116, or to use a dichroic mirror or a vibrating mirror that moves when the emission of RGB beams is switched, thereby to displace the optical axis.

Further, this lens may not be a cylindrical lens formed of segment lens arranged in the vertical direction for the respective pixels, but may be one designed to provide parallaxes in not only horizontal direction, but also the vertical direction. In addition, the light sources 103, the slit shutter 108 and other optical systems may be arranged in the vertical direction. Then, parallaxes can be generated not only in the horizontal direction, but also in the vertical direction.

To generate 120 parallaxes also in the vertical direction, each unit pixel region may be composed of 8 (in the horizontal direction)×9 (in the vertical direction) pixels, the light sources 103 may be re-designed, causing the 1080 pixels arranged in the vertical direction to modulate 9 pixel (in the vertical direction)×120 parallaxes, the slit shutter 108 may be divided to 240 (in the horizontal direction)×120 (in the vertical direction) segments, and the mirror 202 a half-silvered mirror 203 may guide beams to 240×120 (=28,800) pixel regions.

If a diffuser is used, it should better have a function of diffusing light in the vertical direction only. If the diffusion angle is small or if no diffusers are used, an image can be projected onto a screen opposed to the display 109. The image display apparatus 100 can therefore function as one type of a projector. Moreover, the display 109 can be easily modified to have a curved surface. Particularly, the display 109 can be shaped cylindrical with no technical difficulty, only if the half-silvered mirror and the slit shutter are shaped like a cylinder and used in combination with the cylindrical lens.

The process of generating the modulated data item in the light source control unit 101 will be explained with reference to the flowchart of FIG. 6.

In Step S601, luminance and color are calculated for any object point existing on a vector of one parallactic angle of a specific pixel.

In Step S602, it is determined whether or not the calculation has been performed for all parallaxes. In present embodiment, it is determined whether or not the luminance and color have been calculated for object points pertaining to 240 parallaxes.

If the calculation has been complete for all parallaxes, the process proceeds to Step S603. If the calculation has not been performed for all parallaxes, the process will return to Step S601. In Step S601, luminance and color are calculated for the next parallax. Thus, Step S601 is repeated until the calculation has been performed for all parallaxes.

In Step S603, it is determined whether or not the process has been performed on a predetermined number of pixels. If the process has been performed on a predetermined number of pixels, the process proceeds to Step S604. If the process has not been performed on the pixels, the process returns to Step S601. In this case, Steps S601 to S603 are repeated. Note that the “predetermined number of pixels” may be all pixels provided, or the pixels used in each unit pixel region.

In Step S604, the SLM 117 displays the modulated data item. Some time thereafter, Steps S601 to S604 are repeated.

It will be explained how luminance and color are calculated for an object point in Step S601. First, the data item about the object (i.e., person, body or scenery) is generated in a computer. The data item may be an image taken with a camera or a virtual image synthesized by the computer, only if it represents the 3D position, brightness and color of the object, which are determined by the method that will be described later. The data item about the object may relate to the front or back of the display. Next, one parallax of one pixel on the display is determined, and the positions that the eyes of the viewer observing the light beam take on the parallax vector is also determined. Finally, the color and luminance of the intersection nearer to the eyes than any other intersection of the parallax vector and the object are calculated by a computer. The intersection on the back of either eye (i.e., side facing away the display screen) is not taken into account. If the point nearest to the eyes appears translucent, the color and luminance of this point are calculated from the transparency and luminance of the point, taking the second nearest point, et seq., into consideration. To add special effects such as spatial distortion, the method of calculating the color and luminance of any intersection may be changed to another method in accordance with the nature of the special effect. After the calculation for one pixel and one parallax has been completed, the calculation is repeated for all remaining pixels and all remaining parallaxes.

### (Modification of the First Embodiment)

In the embodiment described above, the display 109 displays one multi-parallax 3D image. Nonetheless, different multi-parallax 3D images corresponding to user's positions may be displayed.

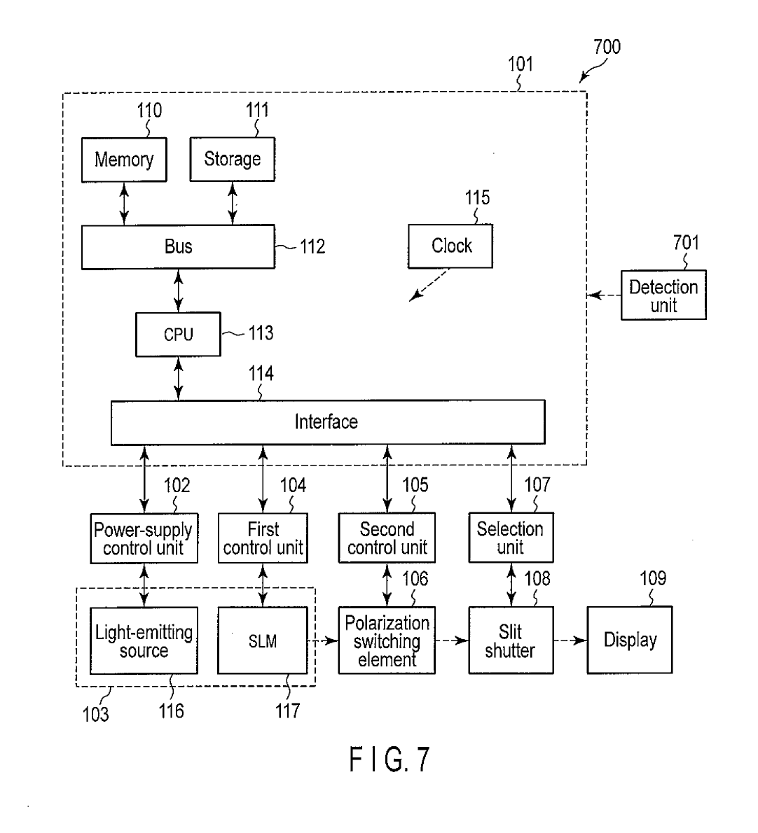

An image display apparatus according to the modified embodiment will be described with reference to the block diagram of FIG. 7.

The image display apparatus 700 according to the modified embodiment includes a detection unit 701 in addition to the components of the apparatus 100 shown in FIG. 1.

The detection unit 701 detects the user position including the position of the user's eyes. The detected user's position is supplied to the light source control unit 101.

For example, 240 parallaxes are divided to left and right groups, each including 120 parallaxes. Thus, if two images that differ in accordance with the position the user takes, they can be displayed to two users at the left side and right side of the display 109, respectively.

The detection unit 701 may detect the position the user takes in the vertical direction. Then, different images can be displayed to the user, in accordance with the sex and age of the user. Generally, the men are taller than women, and women are taller than the children. Hence, if the user's height is greater than or equal to a first threshold value, an image interesting to men is displayed; if the user's height is less than the first threshold value and greater than or equal to a second threshold value, an image interesting to women is displayed; and if the user's height is less than the second threshold value, an image interesting to children is displayed. Thus, images can be displayed in accordance with the users' needs.

The detection unit 701 may be a head tracking device. In this case, a specified user can be tracked down, and an image may be displayed to this user, while different images are displayed to other users.

In the first embodiment described above, a data beam which is image data item including multi-parallax data items for the unit pixel regions and which is emitted at various angles determined by positions from the unit pixel regions selected by a polarization switching element and a slit shutter. The image display apparatus according to the first embodiment can therefore be small, can have a simple configuration, and can generate ultra multi-parallax 3D images.

### Second Embodiment

In the first embodiment, the beam path extending from the light sources 103 to the display 109 is controlled by the polarization switching element 106, PBS 201, mirrors 202, half-silvered mirrors 203 and slit shutter 108. In the second embodiment, a polygon mirror controls the beam path.

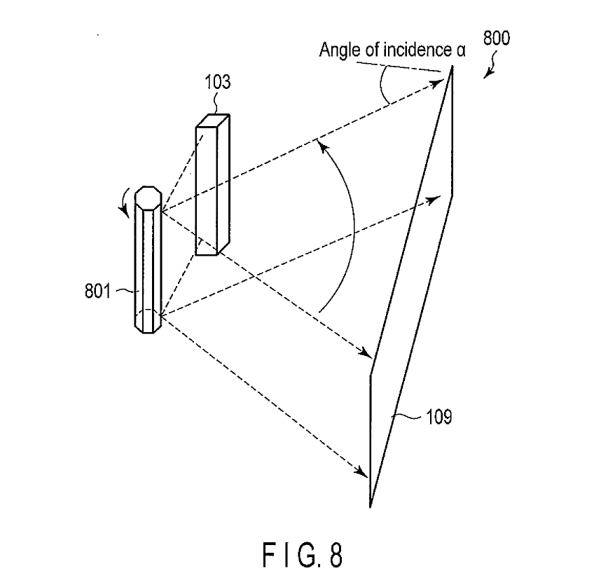

An image display apparatus according to the second embodiment, which has a polygon mirror, will be described with reference to FIG. 8.

As FIG. 8 shows, the image display apparatus 800 includes a light source 103, a polygon mirror 801, and a display 109.

The polygon mirror 801 is an ordinary type shaped like a polygonal column, and has a plurality of mirror surfaces. The polygon mirror 801 can rotate in one direction at an optimal speed. A light beam emitted from the light source 103 is guided to the polygon mirror 801. The polygon mirror 801, which rotates, reflects the light beam, guiding the light beam to the display 109, scanning the pixel regions thereof, one after another, in the horizontal direction from one side of the display screen to the other side of the display screen. As shown in FIG. 8, the polygon mirror 801 rotates counterclockwise, and the data beam emitted from the light source 103 is guided to the display 109, scanning the display 109, from the leftmost pixel region to the rightmost pixel region.

In this case, the angle of incidence, at which the data beam is guided to the display 109, differs in the horizontal direction, from a pixel column to a pixel column. In view of this, the cylindrical lens may be designed in compliance with the angle of incidence, or may be replaced by an optical element (e.g., wedge) that compensates for the difference between the pixel columns in terms of angle of incidence.

In the second embodiment described above, a polygon mirror is used in place of a number of half-silvered mirrors and a slit shutter, whereby ultra multi-parallax 3D images can be displayed as in the first embodiment. Further, the apparatus according to the second embodiment comprises fewer components than the apparatus according to the first embodiment.

### Third Embodiment

The third embodiment is different in that an optical system identical to the system used in the first embodiment detects the external light irradiated the display 109, thereby to display an image in accordance with the external conditions, and that it is used as an ultra multi-parallax camera.

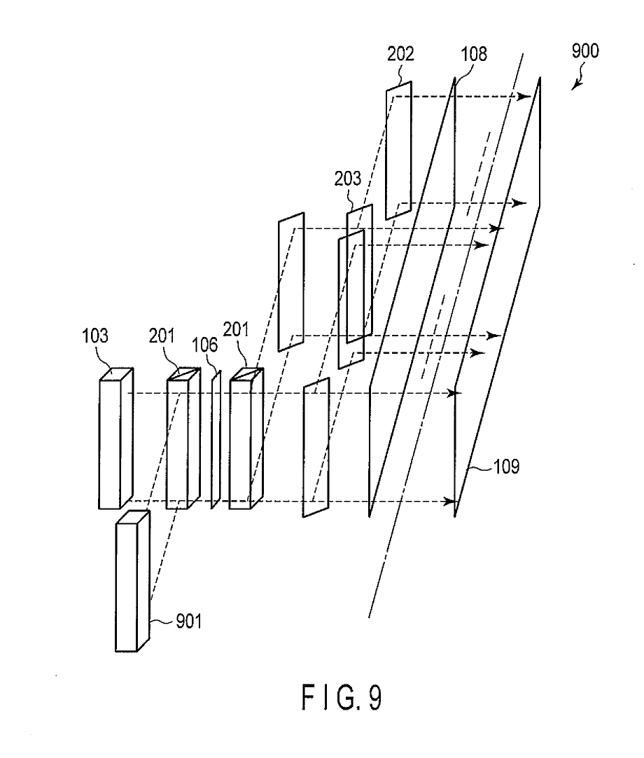

An image display apparatus according to the third embodiment will be described with reference to FIG. 9.

The image display apparatus 900 according to the third embodiment includes a light source 103, a polarization switching element 106, PBSs 201, a light detection element 901, mirrors 202, half-silvered mirrors 203, a slit shutter 108, and a display 109. The image display apparatus 900 differs from the image display apparatus 100 according to the first embodiment, in that two PBSs 201 are used, the polarization switching element 106 is arranged between the two PBSs 201 and the detection element 902 is included.

The light detection element 901 receives a light beam branched at the PBS 201 and detects the intensity of this light beam. The light detection element 901 can detect the intensity of the external light irradiated the display 109, enabling the display 109 to display an image corresponding to the external conditions. Assume that the image display apparatus 900 is set a street. Then, if the light intensity the light detection element 901 has detected exceeds a threshold value as at daytime, the apparatus 900 displays images interesting to, for example, housewives and students. If the light intensity the light detection element 901 has detected falls below the threshold value as in the evening or at night, the apparatus 900 displays images interesting to, for example, office workers.

Assume that the light detection element 901 is an image sensor. Also assume that the diffuser has a small diffusion angle or is not used at all. Then, the image display apparatus 900 may be used as one type of a camera that takes ultra multi-parallax images. If the polarization switching element 106 is not so positioned as shown in FIG. 9, only the external light beam coming from the right side of the display 109 is guided to the light detection element 901, whereas the external light beam coming from the left side of the display 109 is guided back to the light source 103. In order to prevent this event, the external light beam path may not be switched, and the external light beam may be split by, for example, a half-silvered mirror, and the slit shutter 108 may allow the passage of the external light beam to only one pixel region.

In the third embodiment described above, the intensity of the external light is detected, thereby displaying an image that accords with the external conditions. Moreover, the image display apparatus 900 according to the third embodiment can be used as a camera that can take ultra multi-parallax images.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display apparatus, comprising:
a light-emitting source to emit a light beam;
a light modulation unit configured to modulate the light beam to generate data beams related to image data item displayed in a unit pixel region, each of the data beams being determined by a position in a pixel and output angle corresponding to the position, the unit pixel region including at least one column of pixels defined by dividing all pixel region,
a first control unit configured to control beam paths of the data beams to guide the data beams to the unit pixel region; and
a display to display a parallax image by emitting the corresponding data beams from unit pixel regions of the all pixel region.

2. The apparatus according to claim 1, wherein the light modulation unit generates, for each unit pixel region, the data beams as many as a number obtained by multiplying the number of pixels included in the unit pixel region by the number of parallaxes of the parallax image displayed in the display.

3. The apparatus according to claim 1, further comprising a second control unit configured to control colors and intensity of the light beam to generate the data beams related to unit pixel region in time division,
wherein the first control unit controls the beam paths to guide the data beams to the unit pixel region in accordance with the second control unit.

4. The apparatus according to claim 1, wherein the display includes a group of lenses.

5. The apparatus according to claim 1, wherein the first control unit controls the beam paths to guide the data beams to the display using at least one of a mirror and an optical waveguide.

6. The apparatus according to claim 1, wherein the first control unit controls the beam paths to guide the data beams to the unit pixel regions using a shutter.

7. The apparatus according to claim 1, further comprising a first detection unit configured to detect a position of a user, including positions of the user's eyes.

8. The apparatus according to claim 3, wherein the first control unit and the second control unit control the data beams emitted from the display to display a three-dimensional image.

9. The apparatus according to claim 3, wherein the first control unit and the second control unit control the data beams emitted from the display to display one or more parallax images differing in accordance with a plurality of positions of users including positions of user's eyes.

10. The apparatus according to claim 3, further comprising a first detection unit configured to detect a position of a user, including positions of the user's eyes,
wherein the first control unit and the second control unit control the parallax image displayed at the display, in accordance with a position of a user.

11. The apparatus according to claim 1, further comprising a second detection unit configured to detect an intensity of an external light irradiating the display,
wherein the first control unit controls a beam path of the external light to guide the external light to the second detection unit.

12. An image display method, comprising:
emitting a light beam from a light emitting source;
modulating the light beam to generate data beams related to image data item displayed in a unit pixel region, each of the data beams being determined by a position in a pixel and output angle corresponding to the position, the unit pixel region including at least one column of pixels defined by dividing all pixel region,
controlling beam paths of the data beams to guide the data beams to the unit pixel region; and
displaying a parallax image by emitting the corresponding data beams from unit pixel regions of the all pixel region.

13. The method according to claim 12, wherein the modulating the light beam generates, for each unit pixel region, the data beams as many as a number obtained by multiplying the number of pixels included in the unit pixel region by the number of parallaxes of the parallax image displayed.

14. The method according to claim 12, further comprising controlling colors and intensity of the light beam to generate the data beams related to unit pixel region in time division,
wherein the controlling the beam paths controls the beam paths to guide the data beams to the unit pixel region in accordance with controlling the colors and the intensity of the light beam.

15. The method according to claim 12, wherein the displaying the parallax image displays the parallax image using the display includes a group of lenses.

16. The method according to claim 12, wherein the controlling the beam paths controls the beam paths to guide the data beams to the display using at least one of a mirror and an optical waveguide.

17. The method according to claim 12, wherein the controlling the beam paths controls the beam paths to guide the data beams to the unit pixel regions using a shutter.

18. The method according to claim 12, further comprising detecting a position of a user, including positions of the user's eyes.

19. The method according to claim 14, wherein the controlling the beam paths and the controlling the colors and the intensity of the light beam control the data beams to display a three-dimensional image.

20. The method according to claim 14, wherein the controlling the beam paths and the controlling the colors and the intensity of the light beam control the data beams to display one or more parallax images differing in accordance with a plurality of positions of users including positions of the user's eyes.
